(19) United States
(12) Patent Application Publication
(10) Pub. No.: US 2020/0055283 A1
(43) Pub. Date: Feb. 20, 2020

(54) TRANSPARENT DISPLAY

(71) Applicant: NANO-LIT TECHNOLOGIES LIMITED, Edinburgh (GB)

(72) Inventor: Sarah MORGAN, Edinburgh (GB)

(21) Appl. No.: 16/499,702

(22) PCT Filed: Mar. 29, 2018
(86) PCT No.: PCT/GB2018/050879

§ 371 Date: Sep. 30, 2019

(30) Foreign Application Priority Data
Mar. 31, 2017 (GB) 1705203.6

(51) Int. Cl. B32B 17/10; G09F 13/42; C03C 17/22; C09K 11/62

(52) U.S. Cl. CPC B32B 17/10266; B32B 17/10871; G09F 13/42; C03C 2217/74; B32B 17/10788; C03C 17/22; C09K 11/623; B32B 17/1077

(57) ABSTRACT

Described herein is a transparent or translucent substrate at least partially coated with a quantum dot coating such that the coating is invisible in a first non-excited state of the coating and the coating is visible in a second excited state of the coating. Also described herein is a laminate, a glazing unit and a sunroof comprising the described coated substrate. A method of preparing the coated substrate is also described.

### FIELD

The present disclosure relates to products and substrates with quantum dot coatings, methods of manufacturing the same and uses thereof.

### BACKGROUND

For certain applications it is desirable to have transparent or translucent surfaces that can display an image or a message.

See through mesh LED displays allow a certain degree of translucency of light with low wind resistance characteristics, for example for use in outdoor display applications. The displays employ a see-through carbon fibre mesh design to enable certain degree of light to pass through the display. However, this technology is not suitable for use in solid substrates, such as those that would be used as windows or glazing units in architectural or automotive applications.

Transparent LCD or OLED displays have also been used for business advertising and promotion or as TV screens. However, these displays absorb and/or scatter at least portions of the incident light, leading to a low degree of transparency of the display (e.g. up to 15%) or a distortion the real appearance and/or colour of objects placed at the opposite side of the display from a viewer's location. When an image is not being displayed, the substrate appears to be a tinted glass (i.e. with no clear transparency). In order to increase the degree of transparency of the display to be able to observe background and/or objects located behind the display it is necessary to light the area behind the display heavily so that the background and/or objects can be seen through the display. This limits the applications of these types of displays, particularly as windows or glazing units in buildings or vehicles.

It is an object of the present invention to mitigate at least some problems associated with prior art translucent or transparent displays.

### SUMMARY

The present disclosure is based on the finding that substrates, in particular transparent or translucent substrates can be coated with quantum dots in a manner which does not substantially alter the transparency and/or translucency of the substrate. Further, the quantum dot coating may not be visible unless and until exposed to some form of quantum dot excitation or activation stimulus.

In a first aspect there is provided a quantum dot coated substrate. The quantum dot coated substrate may be coated at a particular density expressed as average number of quantum dots per unit area. The quantum dots may be coated at a density of from about 1·10¹³ to about 1·10¹⁹ quantum dot particles/cm². The quantum dots may be coated at a density of from about 1·10¹³ to about 1·10¹⁴ quantum dot particles/cm², from about 1·10¹⁴ to about 1·10¹⁵ quantum dot particles/cm², from about 4·10¹⁵ to about 2·10¹⁸, from about 2·10¹⁵ to about 2·10¹⁶, from about 4·10¹⁵ to about 4·10¹⁶ quantum dot particles/cm², from about 8·10¹⁵ to about 8·10¹⁶ quantum dot particles/cm², from about 2·10¹⁶ to about 2·10¹⁷ quantum dot particles/cm², from about 4·10¹⁶ to about 4·10¹⁷ quantum dot particles/cm², from about 8·10¹⁶ to about 8·10¹⁷ quantum dot particles/cm², from about 1·10¹⁷ to about 1·10¹⁸ quantum dot particles/cm², from about 1·10¹⁸ to about 1·10¹⁹ quantum dot particles/cm².

The substrate may be coated in its entirety. The substrate may be coated at discrete locations.

The substrate that is coated may be a transparent and/or translucent substrate.

Throughout this specification, the terms “comprise”, “comprising” and/or “comprises” is/are used to denote aspects and embodiments of this invention that “comprise” a particular feature or features. It should be understood that this/these terms may also encompass aspects and/or embodiments which “consist essentially of” or “consist of” the relevant feature or features.

One of skill will appreciate that the term “transparent” or “transparency” refers to the optical property of allowing electromagnetic waves to pass through a material (e.g. a substrate) without being scattered. Transparent materials allow the transmission of a large proportion of the light waves through the material. Transparent materials may not reflect light. The proportion of light that is not transmitted is absorbed by the transparent material, but may not be reflected by it. Transparent materials behave as image-preserving surfaces. The light transmitted through a transparent material may be tinted, for example by a coating. The transmittance of a coating described herein may match the transmittance of a substrate where the coating is applied.

Transparent substrates for use in accordance with this disclosure allow a percentage of incident light in a certain spectral region (transmittance %) to pass through them.

The substrate may be clear or colourless. Clear materials may not absorb any portion or wavelength of the incident light. Thus, a clear transparent substrate may allow substantially all the incident light to pass through the substrate. Objects disposed on a different side of the substrate from a viewer's viewpoint may be observed in their true nature (i.e. the shape and/or colour of objects located behind a clear transparent substrate may be observed as if the substrate was not present). Therefore, a clear transparent substrate may not distort the appearance of an object located behind the substrate.

The substrate may be coloured or tinted.

The term “translucency” or “translucent” refers to the optical property of allowing electromagnetic waves to pass through a material while being scattered. Translucent materials allow transmission of all or part of the electromagnetic waves, although said electromagnetic waves may be transmitted in a different direction to the incident radiation. Translucent substrates for use may also reflect part of the electromagnetic waves. Translucent materials do not behave as image-preserving surfaces.

The term “quantum dots” (QD) as used herein may embrace semiconductor quantum dots, core-type quantum dots and/or core-shell quantum dots. The term “quantum dots” may include, for example, alloyed quantum dots, heavy metals and/or heavy metal-free quantum dots. For example, quantum dots for use may comprise cadmium-containing or cadmium-free quantum dots. In some embodiments, the quantum dots for use may be one or more types selected from the group consisting of (but not limited to): CdSe, CdS, CdTe, PbS, PbSe, MgSe, ZnS, InP, CuInS, CuInS2, Mn:ZnSe, InP/ZnS, InPCuInS2/ZnS, CdSxSe1-x/ZnS. The term “quantum dots” may also comprise carbon quantum dots.

Quantum dots may absorb light of a first wavelength and emit light of a second wavelength. Quantum dots may be excited by ultra-violet light to emit violet, blue, green, yellow, orange or red light. Quantum dots may be excited by violet light to emit blue, green, yellow, orange or red light. Quantum dots may be excited by blue light to emit blue, green, yellow, orange or red light. Quantum dots may be excited by green light to emit green, yellow, orange or red light. The combination of violet, blue, green, yellow, orange and red light may cover the whole range of colours of the visible spectrum of light. Other colours such as indigo and cyan are also encompassed by the present disclosure, as would be appreciated by someone skilled in the art.

All such quantum dots are potentially useful in the products and methods described herein.

The quantum dots for use may be excited or activated by any suitable quantum dot activation or excitation source. For example the quantum dots may be activated or excited by electrical and/or optical means. For example, the quantum dots may be optically activated or excited with UV light.

Quantum dots may be activated or excited by optical excitation with light in the region of 190-500 nm. For example, quantum dots may be activated or excited by optical excitation with light in the region of 450 nm.

The quantum dots may be excited by any suitable light source including, for example, LEDs.

Thus a coated substrate according to this disclosure may be exposed to some electrical and/or optical stimulus in order to excite the QD coating. For example a suitable LED may be used to excite the quantum dot coating.

Edge lighting may be used to excite the quantum dot coating. Therefore, the excitation source may comprise a light source directed to a side face of the coated substrate. For example the edge (cross-section or side face) of the coated substrate may be exposed to a source of light in order to excite the quantum dot coating.

The quantum dot coated substrate defined herein may not comprise a light source (which light source would be used to excite the quantum dot coating). Nevertheless, the quantum dot coating may be excited by the lighting module of UK patent application No. 1700141.3. As stated, the excitation source may not be comprised within the quantum dot coated substrate and may not comprise a pressurized lamp filled with an electroluminescent material. Further, the quantum dots may not be coated on the inner surface of a lamp.

The quantum dot coating may be edge lit with a lighting module comprising:

a light source;

an optical mixing element or chamber; and

a colour shift element.

The optical mixing element or chamber of the lighting module may be disposed between the light source and the colour shift element.

The colour shift element of the lighting module may be spaced from the light source. The colour shift element may tune the wavelength and/or spatially homogenise the intensity of the output light from the light source.

The light source of the lighting module may comprise two or more separate or distinct light sources emitting light of different chromaticities or spectral regions.

The colour shift element of the lighting module may comprise quantum dots.

The mixing chamber of the lighting module may comprise a waveguide for injecting the light output from the light source.

The light source of the lighting module may comprise at least one Light Emitting Diode (LED), for example a plurality of LEDs of different chromaticities or spectral regions. The light output of each LED may independently tuneable.

The lighting module may further comprise at least one sensor configured to detect the light output from one or more of:

the light source;

another light or luminaire,

light reflected from the optical mixing element or chamber; and/or

light from the colour shift element.

The at least one sensor may be insensitive to illumination outside the lighting module.

The optical mixing element or chamber may comprise at least one reflective wall to recirculate light inside the mixing chamber prior to exiting the mixing chamber.

A spectral converting diffuser may be disposed between the light source and the optical mixing element or chamber or an opening therein.

The lighting module may comprise a protective seal to prevent contact between the colour shift element and air and/or moisture.

The lighting module may emit white light.

Thus the coated quantum dots or quantum dot coating may define a first non-excited state and a second excited state, wherein the quantum dots move or shift from the non-excited state to the excited state upon exposure to an excitation source as described above.

In the first non-excited state, the absorbance of the coating in the visible region of the electromagnetic spectrum may match the absorbance of the substrate. The transmission of the coating in the visible region of the electromagnetic spectrum may match the transmission of the substrate. The transmission of the coating in the visible region of the electromagnetic spectrum may not alter the optical properties of the substrate (for example the absorbance and transmittance of the coated substrate may remain unchanged compared to the uncoated substrate). The quantum dot coating may be a clear transparent coating in the first non-excited state. The quantum dot coating may be a coloured transparent or non-transparent coating in the second, excited state.

As stated, the substrate may be transparent or translucent to white light illumination and when the quantum dots of the quantum dot coating are in the first state, the portion of the substrate coated with the quantum dot coating may substantially retain its transparency or translucency and/or optical properties. Thus, the quantum dot coating may not substantially affect the transparency or translucency of a substrate under white light illumination. In the first, non-excited state, the quantum dot coating described herein may be transparent under white light illumination (white light illumination comprising a complete mixture of all of the wavelengths of the visible spectrum (in the spectral region from 400 to 750 nm)). In the first, non-excited state, the quantum dot coating described herein may be clear or colourless under white light illumination (for example daylight illumination).

It has been discovered that when a transparent or translucent substrate is coated with quantum dots (QDs) at the stated density of quantum dots on the substrate expressed as average number of quantum dots per unit area, the substrate remains at least partially transparent and/or translucent. In other words, a coated transparent or translucent substrate described herein may present a transmittance comparable to the same uncoated substrate under white light illumination. Films of the quantum dot coating described herein may present transmittance of up to 90% at 10-1200 nm thickness in the visible light spectral region. Films of the quantum dot coating described herein may present transmittance in the region of 30%-90% in the visible light spectral region. For example, films of the conductive material described herein may present transmittance up to 70% in the UV-Vis light spectral region.

The greater the value for transmittance of a coating, the lower impact the coating has on the transparency of a substrate on which it is applied. Low transmittance values indicate that part of the incident light is absorbed, leading to an increase of opacity (i.e. decrease of transparency) of the substrate.

The transmittance of a quantum dot coating in the first, non-excited state may match the transmittance of a substrate on which it is applied. The quantum dot coating may not scatter the light transmitted through a substrate on which it is applied.

While the quantum dot coating may have some effect upon light transmittance through a coated substrate, the effect may be minor or limited. For example, the quantum dot coating may reduce light transmittance by anywhere between about 75% and about 1%. For example, the quantum dot coating may reduce light transmittance by anywhere between about 70%, about 65%, about 60%, about 55%, about 50%, about 45%, about 40%, about 35%, about 30%, about 25%, about 20%, about 15%, about 10% or about 5% and about 1%.

For example, a quantum dot coating applied to a transparent or translucent substrate may reduce light transmittance through that substrate by about 55%, 48% or 29%.

When the quantum dot coating of the quantum dot coated substrate is exposed to a quantum dot excitation or activation source, the quantum dots may be configured to move, shift or pass from the first state to the second excited state whereupon they emit light of a second wavelength. For example, the quantum dot coating may be excited with light in the region of 450 nm and may emit light in the region of 520 to 650 nm.

A pattern may be printed on a transparent or translucent substrate applying a quantum dot coating described herein to discrete portions of the substrate. The pattern may be substantially invisible when the quantum dot coating is in the first, non-excited state. The pattern may be visible when the quantum dot coating is in the second, excited state. Beneficially, a pattern printed on a transparent substrate with a quantum dot coating described herein may be selectively visible to the human eye upon activation of the quantum dot coating.

The substrate to be coated may comprise, consist essentially of or consist of a composite material, a resin, a plastic, a polymer and/or glass. The substrate to be coated may comprise a transparent thermoplastic material or a transparent thermoset material. For example, the substrate to be coated may comprise, consist essentially of or consist of polyvinyl butyral (PVB), ethylene-vinyl acetate (EVA), polycarbonate, and/or thermoplastic polyurethane (TPU).

The quantum dot coated substrate (for example a quantum dot coated PVB substrate) may be overlain by a further substrate or disposed between two or more further substrates. The quantum dot coated substrate may be laminated between two or more further substrates.

Thus in a second aspect there is provided a laminate comprising a quantum dot coated substrate as described herein disposed between two or more further substrates.

The further or two further substrate(s) may comprise any transparent or translucent material. For example the, or both of the, further substrate(s) may comprise, consist essentially of or consist of a plastic and/or glass material. In one embodiment, the one or both further substrate(s) may be (a) glass plate(s) or pane(s).

In embodiments in which the substrate is disposed between two further substrates, each further substrate may be of the same thickness or of a different thickness. In embodiments in which the substrate is disposed between two further substrates, each further substrate may have different optical properties. For example, the first further substrate may be UltraClear™ glass. The quantum dot coating may face the UltraClear™ glass substrate. Beneficially, a further substrate of UltraClear™ glass may not affect the optical properties of the coated substrate. Thus, when the coating is in the second, active configuration, the light emitted by the substrate may be observed through the UltraClear™ glass substrate. The first further substrate may not be a light diffusion film (or substrate) having a back to front haze value of at least 80% and a total back to front light transmission value of at least 50%.

The second further substrate may be a tinted glass, such as an Ultra dark glass. The tinted substrate may be configured to face the outside surface of a vehicle or building. Beneficially, the tinted glass may reflect a portion of the solar heat from sun rays, thus reducing the internal temperature of a space on which the laminate is disposed. Additionally, a tinted glass may reduce sun glare.

Coated substrates according to this disclosure may be prepared using a quantum dot formulation. A quantum dot formulation may comprise quantum dots and a suitable carrier or diluent. The carrier or diluent may be a solvent, for example water or an organic solvent. For example, quantum dots for coating according to this disclosure may be prepared as a colloid in an organic solvent. Quantum dots for coating according to this disclosure may be prepared as a solution or dispersion in an organic solvent. One of skill will be familiar with suitable solvents for use in preparing quantum dot formulations but by way of non-limiting examples, these may include turpentine, acetone, petroleum ether, toluene and/or hexane.

Additional features of the quantum dot formulation are described in more detail below with reference to the third aspect of this disclosure.

A third aspect of this disclosure relates to a method of preparing a quantum dot coated translucent or transparent substrate, said method comprising:

providing a quantum dot formulation; and

applying the quantum dot formulation to at least part of the substrate.

The quantum dot formulation may be provided as a bulk or stock solution or dispersion and an amount or volume may be extracted therefrom and applied to the substrate. The stock solution or dispersion may comprise quantum dots and some form of diluent—for example a solvent. Prior to use, a volume of the quantum dot stock solution may be further diluted. The further dilution step may use the same or a different diluent as was used to prepare the stock solution or dispersion.

The quantum dot formulation may comprise quantum dots at a final concentration of about 1 mg/ml-100 mg/ml. For example, the quantum dot formulation may comprise quantum dots at final concentration of about 2 mg/ml, about 3 mg/ml, about 4 mg/ml, about 5 mg/ml, about 6 mg/ml, about 7 mg/ml, about 8 mg/ml, about 9 mg/ml, about 10 mg/ml, about 15 mg/ml, about 20 mg/ml, about 21 mg/ml, about 22 mg/ml, about 23 mg/ml, about 24 mg/ml, about 25 mg/ml, about 30 mg/ml, about 40 mg/ml, about 50 mg/ml, about 60 mg/ml, about 70 mg/ml, about 80 mg/ml, about 90 mg/ml or about 95 mg/ml.

The quantum dot formulation may comprise quantum dots at a final concentration of about 5 mM to about 100 mM of quantum dot core. For example, the quantum dot formulation may comprise quantum dots at final concentration of about 5 mM, about 6 mM, about 7 mM, about 8 mM, about 9 mM, about 10 mM, about 15 mM, about 20 mM, about 25 mM, about 30 mM, about 32 mM, about 34 mM, about 35 mM, about 38 mM, about 40 mM, about about 42 mM, about 43 mM, about 44 mM, about 45 mM, about 46 mM, about 47 mM, about 50 mM, about 55 mM, about 60 mM, about 65 mM, about 70 mM, about 75 mM, about 80 mM, about 85 mM, about 90 mM, about 95 mM, about 100 mM of quantum dot core. In preferred embodiments the quantum dot formulation may comprise quantum dots at a final concentration of about 5 mM to 40 mM of quantum dot core.

Quantum dot coatings prepared with the quantum dot formulations described herein may be transparent or translucent in a first, non-excited state and may emit light in a second excited state. A pattern printed with a quantum dot coating described herein on a transparent or translucent substrate may be substantially invisible under white light illumination when the quantum dot coating is in the first, non-excited state and the pattern may be visible (for example to the naked human eye under white light illumination or in the dark) when the quantum dot coating in the second, excited state.

The quantum dot formulation may be applied by any suitable method including, for example printing, drop-casting, spin coating, painting, stamping, spraying and the like. A film or layer of QDs may be created on the surface of a substrate (for example a PVB substrate) by drop casting or any other suitable method.

The quantum dot formulation may be applied by drop casting, stamping, spin coating or painting a substrate with a volume of quantum dot formulation. The volume may be selected from between about 1 μL and about 500 μL, about 5 μL, about 10 μL, about 20 μL, about 50 μL, about 70 μL, about 100 μL, about 120 μL, about 150 μL, about 170 μL, about 200 μL, about 250 μL, about 300 μL, about 350 μL, about 400 μL, about 450 μL, about 500 μL per cm² of substrate.

The quantum dot formulation may be applied as a film to at least part of the substrate.

The substrate may comprise, consist essentially of or consist of polyvinyl butyral (PVB). Polyvinyl butyral (PVB) is an amorphous random copolymer of vinyl butyral, vinyl alcohol, and vinyl acetate. The vinyl butyral unit is hydrophobic and promotes good processability, toughness, elasticity and compatibility with many polymers and plasticizers. The hydrophilic vinyl alcohol and vinyl acetate units are responsible for high adhesion to inorganic materials such as glass. PVB films have a certain degree of porosity that can lead to rough topography in films of this material and are hygroscopic and sensitive to oxygen and moisture. Coated substrates may be prepared in a humidity controlled environment.

The quantum dot formulation may comprise quantum dots and a solvent.

The quantum dot formulation may comprise quantum dots and an organic solvent.

The quantum dot formulation may comprise quantum dots and turpentine, toluene and/or hexane.

The quantum dot formulation may comprise or further comprise acetone.

The quantum dot formulation may comprise or further comprise petroleum ether.

The quantum dot formulation may comprise or further comprise a resin (for example a U.V. resin).

The quantum dot formulation may comprise or further comprise a printer ink (for example Smart Ink—Ultra Chrome printer ink).

The quantum dot formulation may comprise or further comprise a glazing medium, charcoal fixative, clear painting medium and/or an oil (for example clarified linseed oil).

Thus the quantum dot formulation may comprise a quantity of quantum dots (QDs) and, optionally, one or more other components selected from the group comprising:

(i) a solvent;

(ii) an organic solvent;

(iii) turpentine, toluene and/or hexane;

(iv) acetone;

(v) petroleum ether;

(vi) a resin;

(vii) a printer ink;

(viii) a glazing medium;

(ix) charcoal fixative;

(x) clear painting medium; and

(xi) an oil (for example clarified linseed oil).

The quantum dot formulation may be applied to discrete locations of the substrate. For example, the quantum dot formulation may be applied in the form of a pattern or image. The pattern or image may comprise, consist or consist essentially of alpha numeric characters.

The quantum dot formulation may be applied using a stencil and/or according to some predetermined pattern. The quantum dot formulation may be applied using a mask comprising the pattern to be applied. The mask may be a vinyl mask. The quantum dot formulation may be applied by fixing the mask to a substrate to be coated and applying the coating to the open portions of the mask such that, upon removal of the mask from the substrate, a pattern made of the quantum dot coating or formulation has been deposited on the substrate. The quantum dot formulation may be applied by means of a stamp.

The substrate may be formed of or comprise any suitable material (as described above) including glass, plastic, composite, resin, polymer and/or plastic materials.

Prior to coating with quantum dots, the substrate may be cooled or refrigerated.

The quantum dot coating may be applied in a humidity controlled environment. For example, the quantum dot coating may be applied in a glove box under inert atmosphere, or in a dehumidified chamber.

Thus according to this disclosure, there is provided a method of providing quantum dot coated PVB, said method comprising:

providing a quantum dot formulation; and

applying a the quantum dot formulation to the PVB; wherein the coated PVB remains translucent and/or transparent.

A quantum dot coating, layer or film prepared from a standard or prior art quantum dot formulation, may be visible when applied to a transparent or translucent substrate (even if the quantum dots are not activated or excited). This is detrimental, since it may not only affect the transparency or translucency of the substrate, but where the substrate is to be used in a vehicle, this may render the substrate unsuitable for this purpose (the quantum dot coating potentially obscuring vision). In contrast, quantum dot coatings, layers or films prepared from quantum dot formulations as described herein may not be visible when applied to transparent or translucent substrates—indeed they may only become visible when excited and/or activated. This makes the substrates, quantum dot formulations and various other products described herein particularly suited to the vehicle (automotive) industry where the technology described herein could be used to produce, for example, windows and sunroofs that do not obscure vision but which can (when subjected to quantum dot excitation or activation conditions) display a quantum dot based image.

Another substrate may be applied to the coated substrate. For example a further substrate may be added to the coated surface such that it covers or overlays the quantum dot coating or quantum dot film applied thereto. In this way, the quantum dot coating is disposed between two substrates. The additional substrate may take the form of a glass plate or pane. Adding a further substrate to the coated substrate may enhance the mechanical stability of the coated surface.

The coated substrate may be sandwiched between two or more additional substrates. In this way, the coated substrate (which substrate is a transparent or translucent substrate) is disposed between two or more additional substrates. A coated substrate disposed or sandwiched between two or more additional substrates may form a laminate. At least one of the two or more additional substrates may be transparent or translucent. All additional substrates may be transparent or translucent. The optical properties of the additional substrates may match the optical properties of the substrate prior to coating. The optical properties of the additional substrates may be identical. The optical properties of the additional substrates may differ from each other. The two or more additional substrates may be glass plates or panes. Sandwiching a coated surface between two or more further substrates may protect the quantum dot coating from degradation, for example by minimising the exposure of the quantum dot coating and/or the quantum dot coated substrate to oxygen.

In embodiments in which the quantum dot coating of a laminate is configured to be excited by an optical excitation source, the coated surface of the substrate may be disposed in contact with the additional substrate (e.g. glass) which is coupled with the optical excitation source. For example, in embodiments in which the quantum dot coating of a laminate is configured to be excited by edge lighting with an LED light source, the coated surface of the substrate (e.g. PVB substrate) may be disposed in contact with the additional substrate (e.g. glass pane) to which the LED light source is coupled. The surface of the substrate which is coated with the quantum dot coating described herein may be adhered to or otherwise secured or fixed to an additional substrate which is configured to be coupled to an optical excitation source. In use, the optical excitation source (e.g. LEDs) may be coupled to the additional substrate (e.g. glass pane) to which the surface of a transparent substrate (e.g. PVB) coated with a quantum dot coating as described herein is adhered to. When the optical excitation source is not switched on, the quantum dot coating may be inactive and therefore substantially invisible to the human eye. When the optical excitation source is switched on, the quantum dot coating may be active and the quantum dots may emit light, thus rendering the coating visible to the human eye.

Where the coated substrate, for example the PVB substrate is to be covered by another substrate (for example a glass plate) or disposed between two additional or further substrates, the substrates (which are stacked or overlain to form a laminate) may be subject to some form of heat treatment. The purpose of the heat treatment being to reduce or substantially eliminate the presence of air between the various substrates. By way of example, the stacked substrates may be subjected to temperatures of between about 100° C. and about 200° C. for a suitable period of time. For example, the laminate or stacked substrates may be subjected to a temperature of about 110° C., about 120° C., about 125° C., about 130° C., about 135° C., about 140° C., about 145° C., about 150° C., about 155° C., about 160° C., about 165° C., about 170° C., about 175° C., about 180° C., about 190° C. or about 195° C.

The suitable period of time may be any period suitable to (substantially eliminate or reduce the presence of air between layered substrates, for example in a laminate. For example, the substrates may be exposed to heat for anywhere between about 1 min and about 60 minutes. For example, heat may be applied to the substrates for about 5 min, about 10 min, about 15 min, about 20 min, about 25 min, about 30 min, about 35 min, about 40 min, about 45 min, about 50 min or about 55 min. In one embodiment of the methods described herein, heat may be applied for about 20 min to about 30 min.

Where the coated substrate, for example the PVB substrate, is to be covered by another substrate (for example a glass plate) or disposed between two additional or further substrates, the substrates (which are stacked or overlain to form a laminate) may be subjected to a vacuum treatment. Vacuum treatment may be applied by introducing the laminate in a vacuum chamber or vacuum bag. The purpose of the vacuum treatment being to reduce or substantially eliminate the presence of air between the various substrates. Substrates stacked or overlain to form laminate as described herein may be subjected to vacuum prior to the application of a heat treatment and/or during the application of a heat treatment and/or after the application of a heat treatment. The pressure inside a vacuum chamber or vacuum bag may be from about 20 kPa to about 80 kPa, from about 30 kPa to about 60 kPa, from about 40 kPa to about 50 kPa. The pressure inside a vacuum chamber or vacuum bag may be about 41 kPa. The pressure differential between inside and outside a vacuum chamber or vacuum bag may be about 30 kPa, about 40 kPa, about 50 kPa, about 60 kPa, about 70 kPa, about 80 KPa, about 90 kPa, or about 100 kPa.

Further, before, after and/or during heating and/or applying vacuum, the layered substrates (laminates) may be subjected to pressure so as to further reduce the presence of air between the layers. For example, the layered substrates may be subject to pressures of between about 0.1 N/cm² to 1 N/cm². For example pressures of about 0.2 N/cm², 0.3 N/cm², 0.4 N/cm², 0.5 N/cm², 0.6 N/cm², 0.7 N/cm², 0.8 N/cm², 0.9 N/cm². The exact pressure to be applied may not be important—rather the pressure applied should be sufficient to force out air present between the (optionally heated and) layered substrates, such that the substrates become layered substantially without air being present therebetween. The pressure and/or heat may be applied in an autoclave vessel.

In one embodiment, the heat and pressure are provided together. That is to say, the layered substrates are heated while under pressure. Indeed the inventors found that heating the layered substrates at 130° C. for 30 minutes while under pressure resulted in a product that exhibit less trapped air between the layers. Reducing the amount of air bubbles trapped between the layers may maintain the transparency of each of the layers, such that the overall appearance of the laminate is transparent.

The technology described herein may find application in the manufacture of glazing components for architecture, such as windows, conservatories, glass partition walls, glass doors, glass furniture and the like.

The technology described herein may find application in the manufacture of glazing components for advertising applications, such as transparent product displays, retail windows, product boxes and the like.

The technology described herein may find application in the manufacture of glazing components for vehicles.

For example, windows and sunroofs for cars, aeroplanes, boats and the like may comprise a QD coated substrate as described herein.

Windows and other glazing units which comprise quantum dot coated substrates as described herein may retain or substantially retain their light transmittance properties (i.e. their transparency and/or translucency) and as such are particularly suited for use in, for example, in the automotive (and general transport) industry where glazed parts—windows, windscreens and sunroofs, must remain transparent and/or translucent.

However, the inclusion of a quantum dot coating layer (or film) which does not substantially alter the transparency or translucency of the substrate allows for the possibility of image display on or within any glazing unit which comprises the quantum dot coated substrate described herein.

For example, where the quantum dots are applied to a substrate in the form of an image, and that coated substrate is placed into or within a glazing unit, that glazing unit can be made to display the image by exposure of the glazing unit to a suitable quantum dot excitation source as described above.

Thus, in a fourth aspect there is provided a glazing unit comprising a quantum dot coated substrate as disclosed herein.

Disclosed herein is window or windscreen for an automobile, comprising a quantum dot coated substrate as disclosed herein.

The disclosure further provides a glazing unit for an automobile sunroof, wherein said glazing unit comprises a quantum dot coated substrate as disclosed herein.

In one embodiment, a glazing unit of this invention may comprise layered substrates, wherein a quantum dot coated substrate as described herein is disclosed between two other substrates so as to provide a glazing unit. The substrate which is quantum dot coated may comprise PVB. The substrates between which the quantum dot coated substrate is disposed may comprise, consist essentially of, or consist of glass (toughened and/or safety glass for example.

In one embodiment, a quantum dot coated substrate according to this invention may be overlain by a single other, for example glass based, substrate. Where the quantum dot coated substrate is disposed between two other substrates, one of those other substrates may be translucent and/or transparent. For example, the substrate which covers or overlays the quantum dot coating may be translucent and/or transparent. The other substrate (placed beneath the quantum dot coated substrate) may be for example, opaque or tinted/coloured.

The various products described herein may comprise multiple stacked (laminated) substrate layers). For example a quantum dot coated substrate according to this disclosure may be disposed within multiple layers of other substrates.

Further, it should be understood that the quantum dot coatings described herein (or rather the quantum dot formulations) may be applied to the production of a range of coated substrates and may find application in the manufacture of various surfaces which, unless and until they are exposed to a quantum dot activation or excitation, appear devoid (or without) a quantum dot coating. For example, the quantum dot formulations of this invention may be used to coat surfaces of dashboards, control panels and other surface within a vehicle and/or cockpit thereof. These surfaces would, upon exposure to a quantum dot excitation or activation stimulus, display (or reveal the quantum dot coating or any image formed thereby).

In a further aspect, there is provided a quantum dot formulation as disclosed herein.

The disclosure also relates to the use of any of the quantum dot formulations for coating substrates and/or surfaces. In particular, the quantum dot formulations may be used to coat translucent or transparent substrates/surfaces.

The disclosure also provides a car comprising a sunroof, wherein the sunroof comprises a coated quantum dot substrate and/or a quantum dot coating or layer as described herein.

It should be understood that the features defined above in accordance with any aspect of the present disclosure or below in accordance with any specific embodiment may be utilised, either alone or in combination with any other defined feature, in any other aspect of the invention.

### BRIEF DESCRIPTION OF THE DRAWINGS

FIG. 1: Transmittance spectra of three laminates comprising a quantum dot coating on PVB sandwiched between two pieces of glass.

FIG. 2: Plot of weight versus temperature obtained from thermogravimetric analysis (TGA) of three quantum dot solutions in dry compressed air to determine the concentration of the solutions.

FIG. 3: Vinyl mask employed for applying a pattern of a quantum dot coating on a substrate.

FIG. 4: Quantum dot coating comprising UV resistant transparent resin disposed on a transparent substrate, the coating being shown in a first, non-excited state (FIG. 4a) and in a second, excited state (FIG. 4b).

FIG. 5: Second laminate comprising a transparent quantum dot coating on transparent PVB substrate sandwiched between two pieces of glass in a first, non-excited state (FIG. 5a) and in a second, excited state (FIG. 5b).

FIG. 6: Another laminate comprising a transparent quantum dot coating on transparent PVB substrate sandwiched between two pieces of glass in a first, non-excited state (FIG. 6a) and in a second, excited state upon edge lighting the laminate with UV light (FIG. 6b).

FIG. 7: yet another laminate comprising a transparent quantum dot coating on transparent PVB substrate sandwiched between two pieces of glass in a first, non-excited state (FIG. 7a) and in a second, excited state upon optical activation of the quantum dot coating with UV light (FIG. 7b).

### DETAILED DESCRIPTION

### Preparation of Quantum Dot Solutions/Dispersions

Stock solutions of quantum dots were prepared by dispersing 0.4 g of CuInS₂/ZnS quantum dots (UbiQD) in 5 mL of solvent (hexane or toluene). After homogenisation, 1 drop of stock solution was diluted in different volumes of solvent (clear turpentine or white spirit). Table 1 shows the dilution ratios employed for each solution:

TABLE 1
Quantum Dot solutions/dispersions

| | | Volume of | | Volume of |
|---|---|---|---|---|
| Solution | Solvent of | stock solution | Dilution | dilution |
| ID | stock solution | (μL) | solvent | solvent (mL) |
| A | Hexane | 70 | turpentine | 0 |
| B | Hexane | 70 | turpentine | 0.5 |
| C | Hexane | 70 | turpentine | 1 |
| D | Hexane | 70 | turpentine | 1.5 |
| E | Hexane | 70 | turpentine | 2 |
| F | Hexane | 70 | white spirit | 0 |
| G | Hexane | 70 | white spirit | 0.5 |
| H | Hexane | 70 | white spirit | 1 |
| I | Hexane | 70 | white spirit | 1.5 |
| J | Hexane | 70 | white spirit | 2 |
| K | Toluene | 70 | turpentine | 0 |
| L | Toluene | 70 | turpentine | 0.5 |
| M | Toluene | 70 | turpentine | 1 |
| N | Toluene | 70 | turpentine | 1.5 |
| O | Toluene | 70 | turpentine | 2 |
| P | Toluene | 70 | white spirit | 0 |
| Q | Toluene | 70 | white spirit | 0.5 |
| R | Toluene | 70 | white spirit | 1 |
| S | Toluene | 70 | white spirit | 1.5 |
| T | Toluene | 70 | white spirit | 2 |

### Determination of Concentration of Quantum Dots in Solution/Dispersion by Thermogravimetric Analysis (TGA)

The concentration of quantum dots was determined by thermogravimetric analysis (Perkin Elmer TGA-4000). The solutions/dispersions of quantum dots were first sonicated for 1 hour to disperse the quantum dots uniformly. 50 μL of solution were deposited in a clean ceramic crucible boat.

The temperature range was ramped from 30° C. to 200° C. with a scan rate of 3 degrees/min and maintained at 200° C. for a hold time of 10 minutes. A continuous flow of dry compressed air (flow rate: 20 mL/min) was applied.

The change in mass over time was observed and compared between the initial mass and final mass after the scam scan. At 200° C., all solvent and surfactants had evaporated and a precipitate of pure inorganic quantum dot powder (solute) was recovered at the base of crucible. The value of final mass of inorganic solute was then used to calculate concentration parameters in mg/mL.

Once the concentration of the solutions was determined, calculations to find the density of Core (CuInS₂) and Shell (ZnS) of the quantum dots were performed, in order to determine the weight percentage of CuInS₂ and ZnS in the quantum dots. The molarity with respect to CuInS₂ was then calculated using the following formula:

Molarity (mol/L)=Mass (g)/[Vol (L)×Molecular Weight (g/mol)].

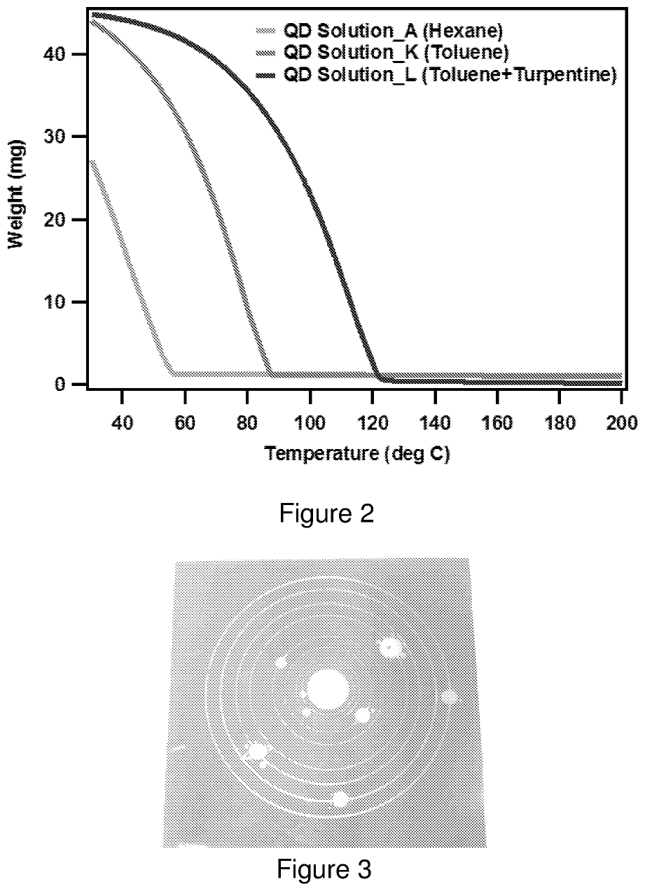

FIG. 2 shows the TGA results obtained for solutions (A, K, L). Laminates prepared with these three solutions provided the best results in the lamination process in terms of transparency of the laminate when the quantum dot coating is not activated and vibrancy of colour of the quantum dot coating when it is activated (see FIGS. 5, 6 and 7).

### Preparation of Laminates

PVB substrates (Solutia RB41 PVB of dimensions 3 cm×3 cm×0.76 mm) were refrigerated overnight at 0-7° C. A quantum dot coating was deposited on each PVB substrate by either drop casting 50 μL of a solution of quantum dots prepared as described above or hand painting a pattern on the PBV substrate using a template of the pattern cut on a vinyl mask (see FIG. 3). The coated substrates were allowed to dry at room temperature for 40 minutes.

A laminate was formed by sandwiching each PBV substrate between two clean clear glass panels (inner glass: 2.1 mm UltraClear™ glass; outer glass: 4 mm tinted Ultra dark glass). The side of the PVB substrate coated with the quantum dot coating was disposed facing and adhered to the inner glass. The inner glass is configured to face the inner space of a vehicle or building such that a viewer can observe a pattern displayed by the quantum dot coating from the inside of the vehicle or building. The outer glass is configured to face the outside surface of a vehicle or building.

The glass-PVB laminate was disposed in a vacuum chamber and vacuum was applied. The glass-PVB laminate was heated in an oven at 22° C. for 1 h under vacuum, the heat was ramped from 22° C. to 98° C. over a period of 3 hours under vacuum and the laminate was maintained at 98° C. for further 3 hours. The heat was ramped from 98° C. to 130° C. over a period of 30 minutes without applying vacuum and the laminate was maintained at 130° C. for 20-30 minutes without applying vacuum to reduce the air content in between the layers of the laminate. The sandwiches were allowed to reach room temperature over 1.5 hours.

After heating the laminates, they were subjected to pressure to minimise the presence of air bubbles in the laminate.

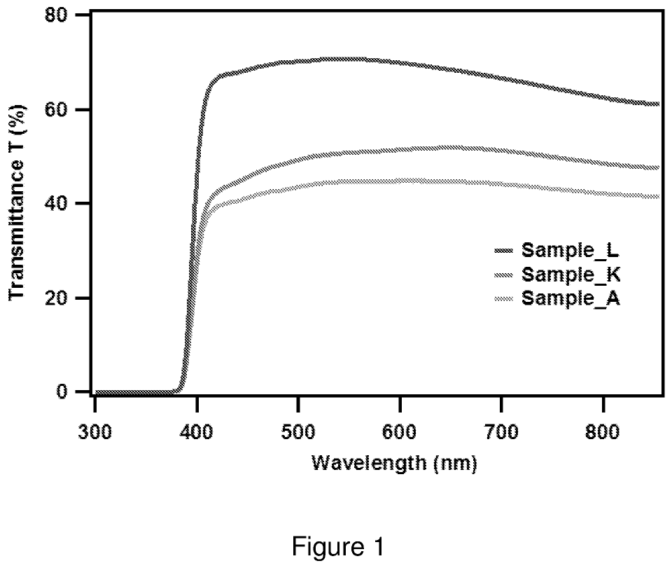

The laminates providing the greatest colour intensity in the excited state of the coating while maintaining a high degree of transparency in the non-excited state of the coating (measured as % transmittance, as shown in FIG. 1) were those prepared with solutions A (hexane stock solution undiluted), K (toluene stock solution undiluted) or L (dilution of toluene stock solution in 0.5 mL turpentine).

In order to apply pressure, the laminates were placed between two slabs of marble, concrete, metal or wood and a soft material (e.g. a fabric cloth) was placed in between the slabs and the laminate to prevent cracking the laminate during the application of pressure. However, pressure may be applied in an industrial process by any other suitable means, such as employing a laminating press, for example a hot laminating press that employs platens or rollers to generate pressure.

The coating of the laminates was excited by coupling a UV lamp (optical excitation source) to the glass panel to which the surface of the PVB coated with the quantum dot coating was adhered. Coupling a UV lamp to the laminate was performed by disposing a UV lamp in contact facing the laminate, for example on a side surface of the laminate to provide edge lighting. When the UV lamp was not switched on, the laminate remained colourless and transparent, and no image was displayed in the laminate (i.e. the coating was invisible to the human eye). When the UV lamp was switched on, the quantum dot coating was excited and emitted light, thus rendering the coating visible, for example displaying a pattern painted or deposited from the quantum dot coating on the PVB coating.

### Measurement of Transmittance of Laminates by UV/Vis/NIR

The optical transparency of the laminates prepared with solutions A, K, and L in visible white light spectrum was measured by UV-Vis spectroscopy using a Perkin Elmer Lambda 750 UV/Vis/NIR spectrometer.

FIG. 1 shows a transmittance spectrum of the three laminates from 300 to 900 nm. It is observed that the laminate prepared with the most diluted solution showed the greatest transmittance, which is an indication of the highest degree of transparency.

### Results

Table 2 shows the results of concentration of quantum dot solutions and the transmittance of laminates prepared with said solutions.

The concentration of the stock solutions A and K was comparable and the dilution factor of stock solution K in turpentine to generate solution L was around 1:7.

The density of quantum dots in each of the slides is provided as an average number of quantum dots per surface area and it is calculated by taking into account the volume employed to drop cast the solution on the substrate (50 μL), the molarity of each solution, Avogadro's number and the area of each of the substrates (9 cm²):

$$Density of quantum dots in substrate = \frac{{volume}_{solution} \cdot {molarity}_{solution}}{area of substrate coated}$$

TABLE 2
Concentration of quantum dot solutions and transmittance of laminates
coated with the solutions

| | | | | | Density of |
|---|---|---|---|---|---|
| | | | Molarity | | quantum dots |
| Laminate | | Concentration | of CuInS₂ | Transmittance | in substrate |
| ID | QD solution | (mg/mL) | (mM) | (%) | (QD/cm²) |
| A | Hexane stock | 22.82 | 47.04 | 45 | 1.57 · 10¹⁷ |
| | solution | | | | |
| K | Toluene stock | 21.22 | 43.76 | 52 | 1.46 · 10¹⁷ |
| | solution | | | | |
| L | Toluene stock | 3.00 | 6.16 | 71 | 2.06 · 10¹⁶ |
| | solution in 0.5 mL | | | | |
| | turpentine | | | | |

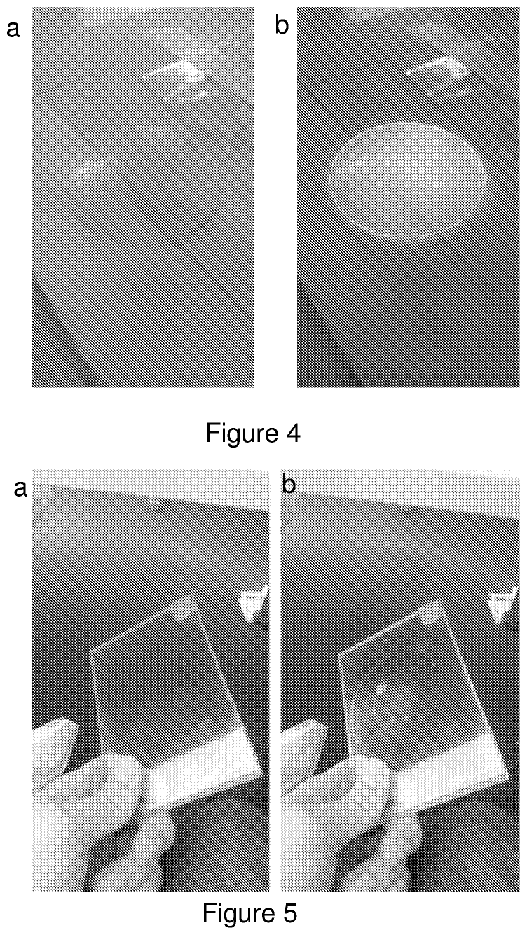

FIG. 4 shows a quantum dot coating prepared by mixing Fxpoxy-Epoxy ultra clear UV resistant resin with quantum dots as a proof of concept. The coating was printed on a clear glass substrate using a Formlabs™ printer. In FIG. 4a it can be observed that the coating is transparent and colourless, and the line present in the wooden surface underneath the glass substrate is visible both through the glass substrate and the quantum dot coating. In FIG. 4b the quantum dot coating is activated by UV optical excitation and as a result the quantum dots in the coating emit blue-violet light. The line on the wooden surface underneath the glass substrate can still be seen through the coating.

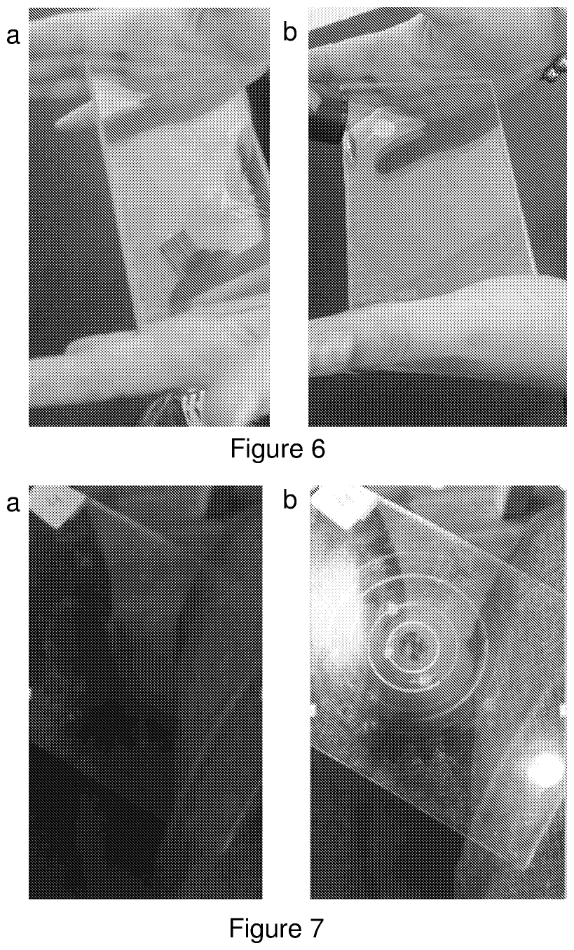

FIGS. 5, 6 and 7 show images of three prototype laminates prepared according to the method described above. As shown in FIGS. 5a, 6a and 7a, the pattern printed on the substrate sandwiched between two pieces of glass in the laminate is not visible when the quantum dot coating of the substrate is in a first, not excited state. The coated substrate is transparent and colourless and objects behind the laminate can be observed through the laminate (see particularly FIG. 6a, in which the foot of the person holding the laminate is visible through the laminate, and FIG. 7a, in which the legs of the person holding the laminate are visible through the laminate and the colour of the trousers is unchanged).

Upon excitation of the quantum dot coating of the laminate with a UV lamp, the pattern printed using a quantum dot coating as described herein is revealed because the quantum dots absorb the UV light and emit light in a different wavelength (see the red and green emission of the pattern in FIGS. 5b, 6b and 7b). FIG. 6b shows that edge lighting the laminate with a UV lamp by directing the UV light to a side face of the substrate efficiently excites the quantum dot coating in the illuminated region, revealing the printed pattern only in the region illuminated by the UV light.

1. A quantum dot coated substrate, comprising:
a transparent or translucent substrate; and
a quantum dot coating applied to at least part of the substrate, the quantum dot coating defining a first non-excited state and a second excited state, the absorbance of the quantum dot coating in the visible region of the electromagnetic spectrum matching the absorbance of the substrate when the coating is in the first non-excited state and the absorbance of the quantum dot coating in the visible region of the electromagnetic spectrum differing from the absorbance of the substrate when the coating is in the second excited state, such that the coating is invisible in the first non-excited state and the coating is visible in the second excited state,
wherein the quantum dots are coated at a density of from about 1·10¹³ to about 1·10¹⁹ quantum dot particles/cm²; and
the quantum dot coating is configured to shift from the first non-excited state to the second excited state upon exposure to an excitation source.

2. The quantum dot coated substrate according to claim 1, wherein the quantum dots comprise cadmium-containing quantum dots and/or cadmium free quantum dots.

3. The quantum dot coated substrate according to claim 1, wherein the excitation source comprises a light source in the region of 190-500 nm.

4. The quantum dot coated substrate according to claim 1, wherein the excitation source is an LED light source.

5. The quantum dot coated substrate according to claim 1, wherein the excitation source comprises a light source disposed at a side face of the substrate.

6. The quantum dot coated substrate according to claim 5, wherein the excitation source comprises a lighting module of UK patent application No. 1700141.3.

7. The quantum dot coated substrate according to claim 1, wherein the transparent or translucent substrate is selected from the group consisting of: polyvinyl butyral (PVB); ethylene-vinyl acetate (EVA); and thermoplastic polyurethane (TPU).

8. The quantum dot coated substrate according to claim 1, wherein the coated substrate is overlain by a further substrate or disposed between two or more further substrates.

9. A laminate comprising a quantum dot coated substrate according to claim 1 disposed between two or more further substrates.

10. The quantum dot coated substrate according to claim 8, wherein the further substrate or substrates comprise transparent or translucent plastic and/or glass material.

11. A method of preparing a quantum dot coated substrate according to claim 1, said method comprising:
providing a quantum dot formulation; and
applying the quantum dot formulation to at least part of the substrate to obtain a coated substrate,
wherein the quantum dot formulation comprises quantum dots and a solvent, the formulation having a quantum dot concentration from about 5 mM to about 100 mM of quantum dot core.

12. The method according to claim 11, wherein the formulation has a quantum dot concentration from about 5 mM to about 40 mM of quantum dot core.

13. The method according to claim 11, wherein the quantum dot formulation comprises quantum dots and one or more other components selected from the group comprising:
(i) a solvent;
(ii) an organic solvent;
(iii) turpentine, toluene and/or hexane;
(iv) acetone;
(v) petroleum ether;
(vi) a resin;
(vii) a printer ink;
(viii) a glazing medium;
(ix) charcoal fixative;
(x) clear painting medium; and
(xi) an oil (for example clarified linseed oil).

14. The method according to claim 11, wherein the quantum dot formulation is applied to discrete locations of the substrate in the form of a pattern.

15. The method according to claim 11, wherein the method comprises a step of forming a laminate by disposing the coated substrate between two or more additional substrates, at least one of the two or more additional substrates being a transparent or translucent substrate,
wherein the coated surface of the substrate is disposed such that it faces the at least one transparent or translucent additional substrate.

16. The method according to claim 15, wherein the method comprises the step of subjecting the laminate to heat treatment at temperatures of between about 100° C. and about 200° C. for about 20 minutes to about 30 minutes.

17. The method according to claim 15, wherein the method comprises the step of subjecting the laminate to a vacuum treatment.

18. The method according to claim 15, wherein the method further comprises the step of subjecting the laminate to pressures of between about 0.1 N/cm² to about 1 N/cm².

19. The method according to claim 18, wherein the method comprises heating the laminate at 130° C. for 30 minutes while under pressure.

20. A glazing unit comprising a quantum dot coated substrate according to claim 1.

21. (canceled)
